(19) United States
(12) Patent Application Publication
(10) Pub. No.: US 2013/0157119 A1
(43) Pub. Date: Jun. 20, 2013

(54) SECONDARY BATTERY

(71) Applicants: Midori Shimura, Tokyo (JP); Daisuke Kawasaki, Tokyo (JP); Masahiro Suguro, Tokyo (JP); Yoko Hashizume, Tokyo (JP); Kazuaki Matsumoto, Tokyo (JP)

(72) Inventors: Midori Shimura, Tokyo (JP); Daisuke Kawasaki, Tokyo (JP); Masahiro Suguro, Tokyo (JP); Yoko Hashizume, Tokyo (JP); Kazuaki Matsumoto, Tokyo (JP)

(73) Assignee: NEC CORPORATION, Tokyo (JP)

(21) Appl. No.: 13/820,289

(22) PCT Filed: Jun. 23, 2011
(86) PCT No.: PCT/JP2011/064408

§ 371 Date: Mar. 1, 2013

(30) Foreign Application Priority Data
Sep. 2, 2010 (JP) 2010-196622

(51) Int. Cl. H01M 2/02

(52) U.S. Cl. CPC H01M 2/0202; H01M 2/0237
USPC 429/163

(57) ABSTRACT

An object is to provide a secondary battery in which decomposition of an electrolyte liquid is suppressed and generation of a gas is reduced, even in the case of using a laminate film as a package. Further, the present exemplary embodiment provides a secondary battery of stacked laminate type comprising an electrode assembly in which a positive electrode and a negative electrode are arranged to face each other, an electrolyte liquid and a package accommodating the electrode assembly and said electrolyte liquid, wherein the negative electrode is formed by binding a negative electrode active substance comprising a metal (a) capable of being alloyed with lithium, a metal oxide (b) capable of occluding and releasing lithium ions and a carbon material (c) capable of occluding and releasing lithium ions, to a negative electrode current collector, with at least one selected from polyimides and polyamideimides, and the electrolyte liquid comprises a predetermined nitrile compound.

### TECHNICAL FIELD

The present exemplary embodiment relates to a secondary battery and in particular to a lithium ion secondary battery.

### BACKGROUND ART

A secondary battery having high energy density is needed due to the rapid expansion of the market of notebook computers, mobile phones, electric cars and the like. As a method for obtaining a secondary battery having high energy density, there has been known a method of using a high capacity negative electrode material, a method of using a non-aqueous electrolyte liquid having good stability, or the like.

Patent document 1 discloses using a silicon oxide or a silicate as a negative electrode active substance for a secondary battery. Patent document 2 discloses a negative electrode for a secondary battery provided with an active substance layer comprising a carbon material particle that can absorb and desorb lithium ions, a metal particle that can be alloyed with lithium and an oxide particle that can absorb and desorb lithium ions. Patent document 3 discloses a negative electrode material for a secondary battery which is formed by coating the surface of particle, which has a structure in which a silicon fine crystal is dispersed in a silicon compound, with carbon.

Patent document 4 discloses using a negative electrode capable of occluding and releasing lithium and a nitrile compound having unsaturated bonds between carbon atoms in an electrolyte liquid.

Patent document 5 discloses an electrolyte liquid comprising a nitrile compound having a specific structure.

Patent document 6 discloses an electrolyte liquid comprising a fluorinated nitrile compound.

Patent document 7 discloses using a negative electrode active substance capable of being alloyed with lithium and an electrolyte liquid comprising a nitrile compound having a saturated chain hydrocarbon group having at least two carbon atoms, a fluorinated cyclic carbonate and carboxylic acid ester.

### CITATION LIST

### Patent Documents

Patent Document 1: JP 06-325765 A

Patent Document 2: JP 2003-123740 A

Patent Document 3: JP 2004-47404 A

Patent Document 4: JP 2003-86247 A

Patent Document 5: JP 2008-166271 A

Patent Document 6: JP 2003-7336 A

Patent Document 7: JP 2009-231261 A

### SUMMARY OF THE INVENTION

### Problem to be Solved by the Invention

However, if a secondary battery utilizing a silicon oxide disclosed in Patent Document 1 as a negative electrode active substance is charged and discharged at 45° C. or higher, there has been a problem in which capacity deterioration associated with the charge/discharge cycle may become significantly large.

The negative electrode for a secondary battery disclosed in Patent Document 2 has an effect in which the volume change of the negative electrode as a whole is relaxed due to different charge/discharge electric potential of three components when lithium is absorbed and desorbed. However, in Patent document 2, there have been some points which have not been sufficiently studied, regarding a relationship among three kinds of components in a state of coexistence, and regarding the binder, an electrolyte liquid, a conformation of an electrode assembly, and an outer packaging body which are indispensable for fabricating a lithium ion secondary battery.

The negative electrode material for a secondary battery disclosed in Patent document 3 also has an effect in which the volume change of the negative electrode as a whole is relaxed. However, in Patent document 3, there have been some points which have not been sufficiently studied, regarding a binder, an electrolyte liquid, a conformation of an electrode assembly, and an outer packaging body which are indispensable for fabricating a lithium ion secondary battery.

In Patent Documents 4 to 7, there have been some points which have not been sufficiently studied, regarding a negative electrode active substance, a negative electrode binder, a conformation of an electrode assembly and a package which are indispensable for fabricating a lithium ion secondary battery.

Further, The case of a secondary battery using a laminate film as the package causes a larger strain of the electrode assembly, when gas is generated, than the case of a secondary battery using a metal can as the package. This is because the laminate film is more liable to be deformed due to the internal pressure of the secondary battery than a metal can. Further, in the case of a secondary battery in which a laminate film is used as a package, when it is sealed, the inner pressure of the battery is generally set to be lower than atmospheric pressure. Thus, the battery does not have extra space, which can easily and directly cause a volume change of the battery and deformation of the electrode assembly when gas is generated.

Then, an object of the present exemplary embodiment is to provide a secondary battery in which decomposition of an electrolyte liquid is suppressed and generation of a gas is reduced, even in the case of using a laminate film as a package.

### Means to Solve the Problem

The present exemplary embodiment relates to a secondary battery of stacked laminate type, comprising an electrode assembly in which a positive electrode and a negative electrode are arranged to face each other, an electrolyte liquid and a package accommodating the electrode assembly and said electrolyte liquid, wherein the negative electrode is formed by binding a negative electrode active substance comprising a metal (a) capable of being alloyed with lithium, a metal oxide (b) capable of occluding and releasing lithium ions and a carbon material (c) capable of occluding and releasing lithium ions, to a negative electrode current collector, with at least one selected from polyimides and polyamideimides, and the electrolyte liquid comprises a nitrile compound that is represented by the following general formula (1).

R₁—CN (1)

[R₁ denotes a substituted or non-substituted saturated hydrocarbon group or a substituted or non-substituted aromatic hydrocarbon group.]

### Effects of the Invention

According to the present exemplary embodiment, the decomposition of electrolyte liquid can be suppressed by using an electrolyte liquid comprising a desired nitrile compound. Therefore, even when using a laminate film as a package, a secondary battery having high performance in which a variation in battery volume or a deformation in electrode assembly is inhibited can be provided.

### BRIEF DESCRIPTION OF THE DRAWINGS

FIG. 1 is a schematic cross-sectional view showing an electrode assembly structure of a layered laminate type secondary battery.

### DESCRIPTION OF EMBODIMENTS

Hereinafter, the present exemplary embodiment will be described in detail.

In the secondary battery according to the present exemplary embodiment, an electrode assembly in which a positive electrode and a negative electrode are arranged to face each other, and an electrolyte liquid are accommodated in a package. The shape of the secondary battery is a stacked laminate type. Hereinafter, a secondary battery of a stacked laminate type will be described.

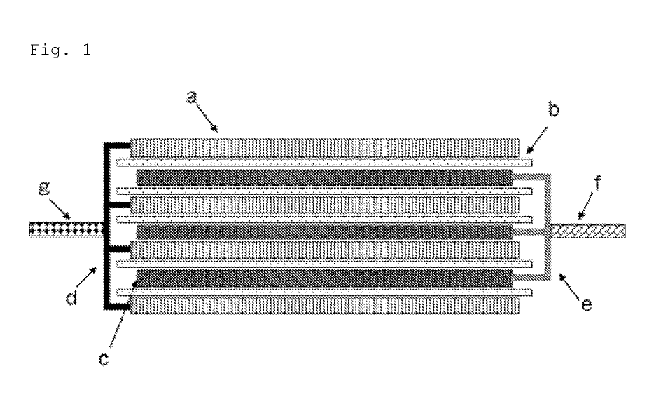

FIG. 1 is a schematic cross-sectional diagram showing a structure of an electrode assembly of a secondary battery of a stacked laminate type. The electrode assembly has a planar stacked structure in which a positive electrode and a negative electrode are arranged to face each other, and the electrode assembly shown in FIG. 1 is formed by alternately stacking a plurality of positive electrodes c and a plurality of negative electrodes a with a separator b being interposed therebetween. Respective positive electrode current collectors e which the positive electrodes c have are mutually welded on the end of the each current collector which is not covered with a positive electrode active substance, to be thereby electrically connected, and further a positive electrode terminal f is welded to the welded portion. Respective negative electrode current collectors d which the negative electrodes a have are mutually welded on the end of the each current collector which is not covered with a negative electrode active substance, to be thereby electrically connected, and further a negative electrode terminal g is welded to the welded portion.

Since an electrode assembly having such a planar stacked structure has no portion of a small R (a region near a winding core of a wound structure), an advantage of the electrode assembly is that it is less adversely affected by volume change of the electrode that occurs in the charge/discharge cycle than an electrode assembly having a wound structure. However, an electrode assembly having a planar stacked structure has a problem that when gas is generated between electrodes, the generated gas is liable to stay between the electrodes. This is because whereas in the case of an electrode assembly having a wound structure, the intervals between the electrodes hardly expand due to a tension exerted on electrodes, in the case of an electrode assembly having a stacked structure, the intervals between the electrodes are liable to expand. In the case where the package is a laminate film, this problem becomes especially remarkable.

The present exemplary embodiment, even in the case where a laminate film is selected as the package, and the electrode assembly has a planar stacked structure, solves the above-mentioned problem, and allows long-life driving even in a stacked laminate-type lithium ion secondary battery using a high energy-type negative electrode.

[1] Negative Electrode

A negative electrode is formed by binding a negative electrode active substance on a negative electrode current collector with a negative electrode binder.

The negative electrode active substance in the present exemplary embodiment contains a metal (a) capable of being alloyed with lithium, a metal oxide (b) capable of occluding and releasing lithium ions and a carbon material (c) capable of occluding and releasing lithium ions.

As metal (a), Al, Si, Pb, Sn, In, Bi, Ag, Ba, Ca, Hg, Pd, Pt, Te, Zn, La, or an alloy of two or more thereof can be used. In particular, it is preferable to contain silicon (Si) as metal (a).

As metal oxide (b), silicon oxide, aluminum oxide, tin oxide, indium oxide, zinc oxide, lithium oxide, or a composite thereof can be used. In particular, it is preferable to contain silicon oxide as metal oxide (b). This is because the silicon oxide is relatively stable and hardly causes reactions with other compounds. To metal oxide (b), one or two or more elements selected from nitrogen, boron and sulfur may be further added, for example, from 0.1 to 5% by mass. Thereby, the electroconductivity of metal oxide (b) can be improved.

As carbon material (c), graphite, amorphous carbon, diamond-like carbon, carbon nanotubes, or a composite thereof can be used. Here, graphite having a high crystallinity has a high electroconductivity, and has excellent adhesiveness with a positive electrode current collector including a metal such as copper, and excellent voltage flatness. By contrast, since amorphous carbon having a low crystallinity exhibits relatively small volume expansion, the amorphous carbon has a high advantage of relaxing the volume expansion of the negative electrode as a whole, and hardly causes deterioration caused by nonuniformity including crystal grain boundaries and defects.

The whole or a part of metal oxide (b) preferably has an amorphous structure. Metal oxide (b) of an amorphous structure can suppress volume expansion of carbon material (c) and metal (a), and can also suppress decomposition of an electrolyte liquid such as one containing a phosphate compound. This mechanism is not clear, but it is presumed that metal oxide (b) having an amorphous structure has some influence on the film formation at the interface between carbon material (c) and the electrolyte liquid. The amorphous structure is believed to have a relatively small constituent due to nonuniformity such as crystal grain boundary or a defect. The whole or a part of metal oxide (b) having an amorphous structure can be confirmed by X-ray diffractometry (common XRD measurement). Specifically, in the case where metal oxide (b) has no amorphous structure, a peak intrinsic to metal oxide (b) is observed, but in the case where the whole or a part of metal oxide (b) has an amorphous structure, a peak intrinsic to metal oxide (b) is observed as a broad peak.

A negative electrode active substance wherein the whole or a part of metal oxide (b) has an amorphous structure, and the whole or a part of metal (a) is dispersed in the metal oxide (b) can be fabricated, for example, by the method as disclosed in Patent Literature 3. That is, subjecting metal oxide (b) to a CVD process under an atmosphere containing an organic gas such as methane gas can give a composite in which metal (a) in the metal oxide (b) is made into nanoclusters and is covered on the surface with carbon material (c). Alternatively, the negative electrode active substance can be fabricated by mixing carbon material (c), metal (a) and metal oxide (b) by mechanical milling.

Metal oxide (b) is preferably an oxide of a metal constituting metal (a). Metal (a) and metal oxide (b) are preferably silicon (Si) and silicon oxide (SiO), respectively.

The whole or a part of metal (a) is preferably dispersed in metal oxide (b). Dispersing at least a part of metal (a) in metal oxide (b) can further suppress the volume expansion of a negative electrode as a whole, and can also suppress the decomposition of an electrolyte liquid. The whole or a part of metal (a) being dispersed in metal oxide (b) can be confirmed by the combined use of the transmission electron microscopic observation (common TEM observation) and the energy dispersive X-ray spectroscopy (common EDX measurement). Specifically, it can be confirmed that the metal constituting the metal particle (a) has not been turned to an oxide of the metal, by observing the cross-section of a sample containing the metal particle (a) and measuring the oxygen concentration of the metal particle (a) dispersed in metal oxide (b).

As described above, the content of metal (a), the content of metal oxide (b) and the content of carbon material (c) with respect to the total of metal (a), metal oxide (b) and carbon oxide (c) are preferably 5% by mass or more and 90% by mass or less, 5% by mass or more and 90% by mass or less, and 2% by mass or more and 80% by mass or less, respectively. Also, the content of metal (a), the content of metal oxide (b) and the content of carbon material (c) with respect to the total of metal (a), metal oxide (b) and carbon material (c) are more preferably 20% by mass or more and 50% by mass or less, 40% by mass or more and 70% by mass or less, and 2% by mass or more and 30% by mass or less, respectively.

Metal (a), metal oxide (b) and carbon material (c) that is used can be, but should not be particularly limited, a particle thereof. For example, the average particle diameter of metal (a) can be constituted to be smaller than the average particle diameters of carbon material (c) and metal oxide (b). With such a constitution, since the particle diameter of metal (a) in which little volume change occurs during the charge/discharge cycle is relatively small and the particle diameters of carbon material (c) and metal oxide (b) in which large volume change occurs are relatively large, the formation of dendrite and the micro-powdering of the alloy can be more effectively suppressed. Lithium is consequently occluded in and released from the large-sized particle, the small-sized particle and the large-sized particle in this order in the charge/discharge process, and also from this point, the generation of the residual stress and the residual strain is suppressed. The average particle diameter of metal (a) can be made to be, for example, 20 μm or smaller, and is preferably made to be 15 μm or smaller.

The average particle diameter of metal oxide (b) is preferably ½ or smaller than that of carbon material (c), and the average particle diameter of metal (a) is preferably ½ or smaller than that of metal oxide (b). It is more preferable that the average particle diameter of metal oxide (b) be ½ or smaller than that of carbon material (c), and the average particle diameter of metal (a) be ½ or smaller than that of metal oxide (b). Controlling the average particle diameters in such ranges can more effectively provide the effect of relaxing the volume expansion of the metal and the alloy phase, and can provide a secondary battery that has excellent balance between energy density, the cycle life and efficiency. More specifically, it is preferable that the average particle diameter of silicon oxide (b) be made to be ½ or smaller than that of graphite (c), and the average particle diameter of silicon (a) be made to be ½ or smaller than that of silicon oxide (b). Still more specifically, the average particle diameter of silicon (a) can be made to be, for example, 20 μm or smaller, and is preferably made to be 15 μm or smaller.

As the negative electrode binder, at least one selected from polyimides (PI) and polyamideimides (PAI) can be used. The use of polyimides or polyamideimides as the negative electrode binder can provide a good cycle characteristic, since the adhesivity between the negative electrode active substance and the current collector is increased, and the electric contact between the current collector and the negative electrode active substance is kept well even if the charge/discharge is repeated.

The content of a negative electrode binder is preferably in the range of 1 to 30% by mass, and more preferably 2 to 25% by mass, with respect to the total amount of a negative electrode active substance and the negative electrode binder. In the case where the content is 1% by mass or more, the adhesivity between active substances or between an active substance and a current collector is increased, and the cycle characteristic becomes to be good. In the case where the content is 30% by mass or less, the active substance ratio is improved, and thereby improve the negative electrode capacity.

The negative electrode current collector is not especially limited, but is preferably aluminum, nickel, copper, silver, or an alloy thereof because of the electrochemical stability. The shape thereof includes a foil, a plate-shape and a mesh-shape.

The negative electrode can be fabricated by forming a negative electrode active substance layer containing a negative electrode active substance and a negative electrode binder, on the negative electrode current collector. A formation method of the negative electrode active substance layer includes a doctor blade method, a die coater method, a CVD method, and a sputtering method. A negative electrode current collector may be made by forming a negative electrode active substance layer in advance, and thereafter forming a thin film of aluminum, nickel or an alloy thereof by a method such as vapor deposition or sputtering.

[3] Positive Electrode

A positive electrode is formed, for example, by binding a positive electrode active substance on a positive electrode current collector with a positive electrode binder so as to cover the positive electrode current collector.

The positive electrode active substance includes lithium manganate having a lamellar structure or lithium manganate having a spinel structure such as LiMnO₂ and LiₓMn₂O₄ (0<x<2); LiCoO₂, LiNiO₂ and materials in which a part of the transition metal thereof are substituted with another metal; lithium transition metal oxides such as LiNi_{1/3}CO_{1/3}Mn_{1/3}O₂, in which the molar ratio of a specific transition metal is not more than one half; and materials which have lithium at a larger amount than the stoichiometric amount in these lithium transition metal oxides. Particularly, Li_{α}Ni_{β}Co_{γ}Al_{δ}O₂ (1≦α≦1.2, β+γ+δ=1, β≧0.7, γ≦0.2) or Li_{α}Ni_{β}Co_{γ}Mn_{δ}O₂ (1≦α≦1.2, β+γ+δ=1, β≧0.6, γ≦0.2) is preferable. The positive electrode active substance can be used singly or in combinations of two or more.

As a positive electrode binder, the same one as the negative electrode binder can be used. Above all, polyvinylidene fluoride is preferable from the viewpoint of versatility and low cost. The amount of a positive electrode binder is preferably 1 to 20% by mass, and more preferably 2 to 10% by mass with respect to the total amount of a positive electrode active substance and a positive electrode binder from the viewpoint of a “sufficient binding force” and “increased energy”, which are in a tradeoff relationship.

As the positive electrode current collector, the same one as the negative electrode current collector can be used.

An electroconductive auxiliary material may be added to a positive electrode active substance layer containing a positive electrode active substance in order to reduce impedance. The electroconductive auxiliary material includes carbonaceous microparticles of graphite, carbon black, acetylene black and the like.

[3] Electrolyte Liquid

An electrolyte liquid used in the present exemplary embodiment comprises a nitrile compound that is represented by the following general formula (1). By using the electrolyte liquid comprising such nitrile compounds, a film may be formed on the surface of negative electrode and decomposition of the electrolyte liquid may be suppressed.

R₁—CN (1)

[R₁ denotes a substituted or non-substituted saturated hydrocarbon group or a substituted or non-substituted aromatic hydrocarbon group.]

In R₁ in the above general formula (1), the saturated hydrocarbon group is preferably a saturated hydrocarbon group having 1-18 carbon atoms in total, more preferably a saturated hydrocarbon group having 1-12 carbon atoms in total, and even more preferably a saturated hydrocarbon group having 1-6 carbon atoms in total. The aromatic hydrocarbon group is preferably an aromatic hydrocarbon group having 6-18 carbon atoms in total, more preferably an aromatic hydrocarbon group having 6-12 carbon atoms in total, and even more preferably an aromatic hydrocarbon group having 6-10 carbon atoms in total.

Also, the saturated hydrocarbon group is preferably a straight-chain hydrocarbon group.

As a substituent for R₁, those selected from the group consisting of alkyl groups, aryl groups, alkoxy groups, amino groups, cyano groups and halogen atoms may be used.

More particularly, examples of the substituent include alkyl groups having 1-6 carbon atoms (such as methyl group, ethyl group, propyl group, iso-propyl group and butyl group), aryl groups having 6-10 carbon atoms (such as phenyl group and naphthyl group), alkoxy groups having 1-6 carbon atoms (such as methoxy group, ethoxy group, n-propoxy group, iso-propoxy group, n-butoxy group and tert-butoxy group), amino groups (such as dimethylamino group, methylamino group, ethylamino group and diethylamino group), cyano groups, halogen atoms (such as fluorine atom, chlorine atom and bromine atom), and the like. Also, alkyl groups, aryl groups or alkoxy groups as the substituent may be those having at least one hydrogen atom substituted with halogen atoms, preferably with fluorine atom or chlorine atom. Amino groups as the substituent include alkyl-substituted amino groups, and at least one hydrogen atom of an alkyl group in the alkyl-substituted amino groups may be substituted with a cyano group.

The nitrile compound may be used alone or in a combination of two or more kinds.

Also, R₁ has preferably at least one halogen atom, and more preferably at least one fluorine atom.

Preferably, the nitrile compound is also a compound that is represented by following general formula (2).

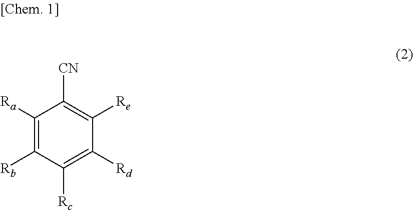

[Ra to Re denote each independently hydrogen atom, an alkyl group, a cyano group or a halogen atom.]

Any one of Ra to Re is preferably fluorine atom.

In addition, it is also preferred that the nitrile compound function as a solvent.

A content of the nitrile compound in an electrolyte liquid is not particularly limited, but is preferably 0.1-30% by mass, more preferably 0.5-20% by mass, and even more preferably 1-5% by mass. In the case where the content is 0.1% by mass or more, a film can be effectively formed on the surface of negative electrode and the decomposition of electrolyte liquid can be more effectively suppressed. In the case where the content is 30% by mass or less, the increasing of the internal resistance of a battery due to the excessive growth of a SEI film can be easily suppressed.

In addition to the nitrile compounds, the electrolyte liquid generally comprises a non-aqueous electrolyte solvent. The non-aqueous electrolyte solvent is not particularly limited, but includes aprotic organic solvents including, for example, cyclic-type carbonates such as propylene carbonate (PC), ethylene carbonate (EC), butylene carbonate (BC), vinylene carbonate (VC) or the like; linear-type carbonates such as dimethyl carbonate (DMC), diethyl carbonate (DEC), ethyl methyl carbonate (EMC), dipropyl carbonate (DPC) or the like; propylene carbonate derivatives; aliphatic carboxylate esters such as methyl formate, methyl acetate, ethyl propionate or the like; and the like. The non-aqueous electrolyte solvent is preferably cyclic-type or linear-type carbonates such as ethylene carbonate (EC), propylene carbonate (PC), butylene carbonate (BC), vinylene carbonate (VC), dimethyl carbonate (DMC), diethyl carbonate (DEC), ethyl methyl carbonate (EMC), dipropyl carbonate (DPC) and the like. The non-aqueous electrolyte solvent can be used alone or in a combination of two or more kinds.

In the present exemplary embodiment, as a nonaqueous electrolyte solvent, a cyclic-type or linear-type carbonate is preferably used. Carbonate has advantages of improving the ionic dissociation of an electrolyte liquid due to its large relative permittivity, and of improving the ionic mobility due to ability of decreasing the viscosity of the electrolyte liquid. However, if a carbonate having a carbonate structure is used as an electrolyte liquid, the carbonate is liable to be decomposed to generate gas including CO2. Particularly in the case of a stacked laminate-type secondary battery, if the gas is generated in the interior, the swelling problem remarkably occurs, thereby being liable to lead to the performance reduction. Then, in the present exemplary embodiment, by adding a nitrile compound to the carbonate, the nitrile compound can suppress the decomposition of an electrolyte liquid, thereby can suppress the generation of the gas. Therefore, in the present exemplary embodiment, an electrolyte liquid preferably contains a nitrile compound and a cyclic-type or linear-type carbonate. Making an electrolyte liquid such a constitution can reduce problems including the gas generation even in the use of a carbonate as an electrolyte liquid, and can provide a high-performance secondary battery. The content of a nitrile compound is preferably 1 to 30% by mass, more preferably 1 to 20% by mass, and even more preferably 1 to 5% by mass with respect to the total amount of the nitrile compound and a carbonate.

The electrolyte liquid further contains a supporting salt. The supporting salt includes lithium salts including, for example, LiPF₆, LiAsF₆, LiAlCl₄, LiClO₄, LiBF₄, LiSbF₆, LiCF₃SO₃, LiC₄F₉SO₃, Li(CF₃SO₂)₂ and LiN(CF₃SO₂)₂. The supporting salts can be used singly or in combinations of two or more.

[4] Separator

As a separator, porous films or non-woven fabrics of polypropylene, polyethylene or the like can be used. As the separator, laminated ones thereof can also be used.

[5] Package

A package is a laminate film. Materials used for the laminate film are not particularly limited, but aluminum, silica-coated polypropylene, polyethylene and the like may be used. Particularly, it is preferred to use an aluminum laminate film in terms of inhibiting a volume expansion.

In the present exemplary embodiment, since the generation of gas can be suppressed even in the case of using a laminate film as the package, the deformation including swelling due to the internal pressure of a secondary battery can be suppressed. Thereby, a lithium ion secondary battery of a stacked laminate type can be provided which is inexpensive and in which there is more broad latitude to change cell capacity by altering the stacking number.

### EXAMPLES

Hereinafter, the present exemplary embodiment will be described specifically by way of Examples.

### Example 1

A silicon of 5 μm in average particle diameter as metal (a), an amorphous silicon oxide (SiOₓ, 0<x≦2) of 13 μm in average particle diameter as metal oxide (b), and graphite of 30 μm in average particle diameter as carbon material (c) were weighed in the mass ratio of 29:61:10. Then, these materials were mixed for 24 hours by so-called mechanical milling to thereby obtain a negative electrode active substance. In the negative electrode active substance, the silicon that is metal (a) was dispersed in silicon oxide (SiOₓ, 0<x≦2) that is metal oxide (b).

The negative electrode active substance (average particle diameter: D₅₀=5 μm) and a polyimide (made by UBE Industries, Ltd., trade name: U Varnish A) as a negative electrode binder were weighed in the mass ratio of 85:15, and mixed with n-methylpyrrolidone to thereby prepare a negative electrode slurry. The negative electrode slurry was applied on a copper foil having a thickness of 10 μm, thereafter dried, and further subjected to a thermal treatment at 300° C. under a nitrogen atmosphere to thereby fabricate a negative electrode. In Table 1, the content (%) of a negative electrode binder indicates the content (% by mass) of the negative electrode binder in the negative electrode active substance and the negative electrode binder.

Lithium nickelate (LiNi_{0.80}Co_{0.15}Al_{0.15}O₂) as a positive electrode active substance, carbon black as an electroconductive auxiliary material, and polyvinylidene fluoride as a positive electrode binder were weighed in a mass ratio of 90:5:5. Then, these materials were mixed with n-methylpyrrolidone to thereby prepare a positive electrode slurry. The positive electrode slurry was applied to an aluminum foil having a thickness of 20 μm, thereafter dried, and further pressed to thereby fabricate a positive electrode.

Three layers of the obtained positive electrode and four layers of the obtained negative electrode were alternately stacked with a polypropylene porous film as a separator being interposed therebetween. Ends of the positive electrode current collectors which were not covered with the positive electrode active substance, and ends of the negative electrode current collectors which were not covered with the negative electrode active substance were each welded. Further to the respective welded portions, a positive electrode terminal made of aluminum and a negative electrode terminal made of nickel were respectively welded to thereby obtain an electrode assembly having a planar stacked structure.

On the other hand, butyronitrile as a nitrile compound and a carbonate non-aqueous electrolyte solvent were mixed in a proportion of 2 parts by mass and 98 parts by mass, respectively, to thereby prepare a mixed solution. LiPF₆ as a supporting salt was further dissolved in a concentration of 1 mol/l in the mixed solution to thereby prepare an electrolyte liquid. The carbonate non-aqueous electrolyte solvent used was a mixed solvent of EC/PC/DMC/EMC/DEC=20/20/20/20/20 (volume ratio). In Table 1, the content (%) indicates the content (% by mass) of the nitrile compound in the nitrile compound and a carbonate non-aqueous electrolyte solvent.

The electrode assembly was packed with an aluminum laminate film as a package; and the electrolyte liquid was injected in the interior, and then sealed while the pressure was reduced to 0.1 atm, to thereby fabricate a secondary battery.

### <Evaluation>

### (20° C. Cycle)

A test of repeating charge/discharge in the voltage range from 2.5 V to 4.1 V in a constant-temperature bath held at 20° C. was carried out on the fabricated secondary battery to thereby evaluate the maintenance rate (%) and the swelling (%). The results are shown in Table 1. In Table 1, the “maintenance rate (%)” represents (a discharge capacity at 150th cycle)/(a discharge capacity at the first cycle)×100 (unit: %). The “swelling (volume increase)(%)” represents {(a volume at 150th cycle)/(a volume at the first cycle)−1}×100 (%)(unit: %).

### (60° C. Cycle)

A test of repeating charge/discharge in the voltage range from 2.5 V to 4.1 V in a constant-temperature bath held at 60° C. was carried out on the fabricated secondary battery to thereby evaluate the maintenance rate (%) and the swelling (%). The results are shown in Table 1. In Table 1, the “maintenance rate (%)” represents (a discharge capacity at 50th cycle)/(a discharge capacity at the first cycle)×100 (unit: %). The “swelling (volume increase)(%)” represents {(a volume at 50th cycle)/(a volume at the first cycle)−1}×100(%)(unit: %).

### Example 2-58

Secondary batteries were fabricated and evaluated in the same manner as in Example 1, except that the kinds of the negative electrode binders and the kinds of the nitrile compounds were selected as shown in Tables 1 to 3. The results are shown in Tables 1 to 3.

### Example 59

According to the method described in Patent Document 3, a negative electrode active substance was obtained which contained a silicon, an amorphous silicon oxide (SiOₓ, 0<x≦2), and a carbon in the mass ratio of 29:61:10. In the negative electrode active substance, the silicon as metal (a) was dispersed in the amorphous silicon oxide as metal oxide (b). Then, the present Example was carried out in the same manner as Example 1, except that this negative electrode active substance was used. The results are shown in Table 3.

### Example 60

The present Example was carried out in the same manner as Example 4, except that the negative electrode active substance used in Example 59 was used. The results are shown in Table 3.

### Example 61

The present Example was carried out in the same manner as Example 7, except that the negative electrode active substance used in Example 59 was used. The results are shown in Table 4.

### Example 62

The present Example was carried out in the same manner as Example 11, except that the negative electrode active substance used in Example 59 was used. The results are shown in Table 4.

### Example 63

The present Example was carried out in the same manner as Example 16, except that the negative electrode active substance used in Example 59 was used. The results are shown in Table 4.

### Example 64

The present Example was carried out in the same manner as Example 22, except that the negative electrode active substance used in Example 59 was used. The results are shown in Table 4.

### Comparative Examples 1-3

Secondary batteries were fabricated and evaluated in the same manner as Example 1, except that the kinds of the negative electrode binders shown in Table 4 was used, and except for not using an nitrile compound. The results are shown in Table 4.

### Comparative Example 4

A Secondary battery was fabricated and evaluated in the same manner as Example 1, except that the kind of the negative electrode binder and the kind of the nitrile compound shown in Table 4 was used. The results are shown in Table 4.

### Comparative Examples 5 and 6

Secondary batteries were fabricated and evaluated in the same manner as Example 1, except that graphite as the negative electrode active substance and the kinds of the negative electrode binders shown in Table 4 were used, and except for not using a nitrile compound. The results are shown in Table 4.

TABLE 1

| | | | | | | 20° C. Cycle | | | | 60° C. Cycle | | | |
|---|---|---|---|---|---|---|---|---|---|---|---|---|---|
| | | Negative | | | | Maintenance | | Swelling | | Maintenance | | Swelling | |
| | | Electrode Binder | | | | Rate | | <Volume> | | Rate | | <Volume> | |
| | Si/SiO/C | | Content | | Content | | Judg- | | Judg- | | Judg- | | Judg- |
| | Ratio | Kind | (%) | Nitrile compound | (%) | (%) | ment | (%) | ment | (%) | ment | (%) | ment |
| Example 1 | 29/61/10 | PI | 15 | Butyronitrile | 2 | 79 | ∘ | 2 | ∘ | 77 | ∘ | 7 | ∘ |
| Example 2 | 29/61/10 | PI | 15 | Valeronitrile | 2 | 78 | ∘ | 2 | ∘ | 65 | ∘ | 7 | ∘ |
| Example 3 | 29/61/10 | PI | 15 | Heptanenitrle | 2 | 70 | ∘ | 4 | ∘ | 68 | ∘ | 9 | ∘ |
| Example 4 | 29/61/10 | PI | 15 | 2-aminoaceto- | 2 | 68 | ∘ | 3 | ∘ | 61 | ∘ | 12 | ∘ |
| | | | | nitrile | | | | | | | | | |
| Example 5 | 29/61/10 | PI | 15 | Dmethylamino- | 2 | 80 | ∘ | 2 | ∘ | 78 | ∘ | 7 | ∘ |
| | | | | acetonitrile | | | | | | | | | |
| Example 6 | 29/61/10 | PI | 15 | Tetramethyl- | 2 | 74 | ∘ | 4 | ∘ | 72 | ∘ | 10 | ∘ |
| | | | | nitrile succinate | | | | | | | | | |
| Example 7 | 29/61/10 | PI | 15 | Malonitrile | 2 | 81 | ∘ | 1 | ∘ | 79 | ∘ | 6 | ∘ |
| Example 8 | 29/61/10 | PI | 15 | Glutaronitrile | 2 | 78 | ∘ | 2 | ∘ | 76 | ∘ | 7 | ∘ |
| Example 9 | 29/61/10 | PI | 15 | 2-methyl nitrile | 2 | 70 | ∘ | 2 | ∘ | 68 | ∘ | 8 | ∘ |
| | | | | glutaric acid | | | | | | | | | |
| Example 10 | 29/61/10 | PI | 15 | 3,3′-iminodi- | 2 | 81 | ∘ | 1 | ∘ | 62 | ∘ | 8 | ∘ |
| | | | | propionitrile | | | | | | | | | |
| Example 11 | 29/61/10 | PI | 15 | Adiponitrile | 2 | 75 | ∘ | 3 | ∘ | 68 | ∘ | 8 | ∘ |
| Example 12 | 29/61/10 | PI | 15 | Pimelonitrile | 2 | 70 | ∘ | 4 | ∘ | 68 | ∘ | 12 | ∘ |
| Example 13 | 29/61/10 | PI | 15 | Sbelonitrile | 2 | 67 | ∘ | 5 | ∘ | 72 | ∘ | 10 | ∘ |
| Example 14 | 29/61/10 | PI | 15 | Azelanitrile | 2 | 70 | ∘ | 6 | ∘ | 72 | ∘ | 11 | ∘ |
| Example 15 | 29/61/10 | PI | 15 | 1,3,6-hexane- | 2 | 72 | ∘ | 4 | ∘ | 70 | ∘ | 9 | ∘ |
| | | | | tricarbonitrile | | | | | | | | | |
| Example 16 | 29/61/10 | PI | 15 | Benzonitrile | 2 | 76 | ∘ | 2 | ∘ | 74 | ∘ | 7 | ∘ |
| Example 17 | 29/61/10 | PI | 15 | p-tolunitrile | 2 | 77 | ∘ | 2 | ∘ | 75 | ∘ | 7 | ∘ |
| Example 18 | 29/61/10 | PI | 15 | Phtalonitrile | 2 | 80 | ∘ | 1 | ∘ | 78 | ∘ | 10 | ∘ |
| Example 19 | 29/61/10 | PI | 15 | 4-tert-t-butyl- | 2 | 71 | ∘ | 3 | ∘ | 69 | ∘ | 8 | ∘ |
| | | | | phtalonitrile | | | | | | | | | |
| Example 20 | 29/61/10 | PI | 15 | 2,2,2-trifluoro- | 2 | 82 | ∘ | 4 | ∘ | 70 | ∘ | 6 | ∘ |
| | | | | acetonitrile | | | | | | | | | |

TABLE 2

| | | | | | | 20° C. Cycle | | | | 60° C. Cycle | | | |
|---|---|---|---|---|---|---|---|---|---|---|---|---|---|
| | | Negative | | | | Maintenance | | Swelling | | Maintenance | | Swelling | |
| | | Electrode Binder | | | | Rate | | <Volume> | | Rate | | <Volume> | |
| | Si/SiO/C | | Content | | Content | | Judg- | | Judg- | | Judg- | | Judg- |
| | Ratio | Kind | (%) | Nitrile compound | (%) | (%) | ment | (%) | ment | (%) | ment | (%) | ment |
| Example 21 | 29/61/10 | PI | 15 | 3-(2-fluoro- | 2 | 73 | ∘ | 3 | ∘ | 68 | ∘ | 8 | ∘ |
| | | | | ethoxy)propionitrile | | | | | | | | | |
| Example 22 | 29/61/10 | PI | 15 | 2,5-difluoro- | 2 | 76 | ∘ | 3 | ∘ | 51 | ∘ | 13 | ∘ |
| | | | | benzonitrile | | | | | | | | | |
| Example 23 | 29/61/10 | PI | 15 | Tetrafluoro- | 2 | 69 | ∘ | 5 | ∘ | 52 | ∘ | 18 | ∘ |
| | | | | phtalonitrile | | | | | | | | | |
| Example 24 | 29/61/10 | PI | 15 | 4-fluorobenzo- | 2 | 70 | ∘ | 7 | ∘ | 58 | ∘ | 9 | ∘ |
| | | | | nitrile | | | | | | | | | |
| Example 25 | 29/61/10 | PI | 15 | 4-bromo-2- | 2 | 71 | ∘ | 6 | ∘ | 57 | ∘ | 15 | ∘ |
| | | | | fluoronitrile | | | | | | | | | |
| Example 26 | 29/61/10 | PI | 15 | Bromoacetonitrile | 2 | 69 | ∘ | 4 | ∘ | 67 | ∘ | 11 | ∘ |
| Example 27 | 29/61/10 | PI | 15 | α-bromo- | 2 | 74 | ∘ | 4 | ∘ | 72 | ∘ | 11 | ∘ |
| | | | | benzeneacetonitrile | | | | | | | | | |
| Example 28 | 29/61/10 | PI | 15 | 4-bromo- | 2 | 76 | ∘ | 2 | ∘ | 74 | ∘ | 7 | ∘ |
| | | | | benzylcyanide | | | | | | | | | |
| Example 29 | 29/61/10 | PI | 15 | 4-chloro- | 2 | 72 | ∘ | 6 | ∘ | 57 | ∘ | 15 | ∘ |
| | | | | benzonitrile | | | | | | | | | |
| Example 30 | 29/61/10 | PAI | 15 | Butyronitrile | 2 | 81 | ∘ | 1 | ∘ | 79 | ∘ | 6 | ∘ |
| Example 31 | 29/61/10 | PAI | 15 | Valeronitrile | 2 | 79 | ∘ | 2 | ∘ | 65 | ∘ | 7 | ∘ |
| Example 32 | 29/61/10 | PAI | 15 | Heptanenitrile | 2 | 72 | ∘ | 3 | ∘ | 70 | ∘ | 8 | ∘ |
| Example 33 | 29/61/10 | PAI | 15 | 2-aminoacetonitrile | 2 | 70 | ∘ | 5 | ∘ | 61 | ∘ | 12 | ∘ |
| Example 34 | 29/61/10 | PAI | 15 | Dimethylamino- | 2 | 81 | ∘ | 2 | ∘ | 79 | ∘ | 7 | ∘ |
| | | | | acetonitrile | | | | | | | | | |
| Example 35 | 29/61/10 | PAI | 15 | Tetramethyl- | 2 | 75 | ∘ | 4 | ∘ | 73 | ∘ | 10 | ∘ |
| | | | | succinatenitrile | | | | | | | | | |
| Example 36 | 29/61/10 | PAI | 15 | Malononitrile | 2 | 81 | ∘ | 2 | ∘ | 79 | ∘ | 7 | ∘ |
| Example 37 | 29/61/10 | PAI | 15 | Glutaronitrile | 2 | 80 | ∘ | 3 | ∘ | 78 | ∘ | 8 | ∘ |
| Example 38 | 29/61/10 | PAI | 15 | 2-methyl- | 2 | 72 | ∘ | 4 | ∘ | 70 | ∘ | 8 | ∘ |
| | | | | glutaratenitrile | | | | | | | | | |
| Example 39 | 29/61/10 | PAI | 15 | 3,3′-iminodi- | 2 | 81 | ∘ | 3 | ∘ | 62 | ∘ | 8 | ∘ |
| | | | | propionitrile | | | | | | | | | |
| Example 40 | 29/61/10 | PAI | 15 | Adiponitrile | 2 | 75 | ∘ | 4 | ∘ | 68 | ∘ | 9 | ∘ |

TABLE 3

| | | | | | | 20° C. Cycle | | | | 60° C. Cycle | | | |
|---|---|---|---|---|---|---|---|---|---|---|---|---|---|
| | | Negative | | | | Maintenance | | Swelling | | Maintenance | | Swelling | |
| | | Electrode Binder | | | | Rate | | <Volume> | | Rate | | <Volume> | |
| | Si/SiO/C | | Content | | Content | | Judg- | | Judg- | | Judg- | | Judg- |
| | Ratio | Kind | (%) | Nitrile compound | (%) | (%) | ment | (%) | ment | (%) | ment | (%) | ment |
| Example 41 | 29/61/10 | PAI | 15 | Pimelonitrile | 2 | 70 | ∘ | 5 | ∘ | 68 | ∘ | 12 | ∘ |
| Example 42 | 29/61/10 | PAI | 15 | Sbelonitrile | 2 | 73 | ∘ | 2 | ∘ | 72 | ∘ | 7 | ∘ |
| Example 43 | 29/61/10 | PAI | 15 | Azelanitrile | 2 | 72 | ∘ | 4 | ∘ | 72 | ∘ | 9 | ∘ |
| Example 44 | 29/61/10 | PAI | 15 | 1,3,6-hexanetricarbonitrile | 2 | 72 | ∘ | 5 | ∘ | 70 | ∘ | 10 | ∘ |
| Example 45 | 29/61/10 | PAI | 15 | Benzonitrile | 2 | 76 | ∘ | 2 | ∘ | 74 | ∘ | 7 | ∘ |
| Example 46 | 29/61/10 | PAI | 15 | p-tolunitrile | 2 | 77 | ∘ | 3 | ∘ | 75 | ∘ | 8 | ∘ |
| Example 47 | 29/61/10 | PAI | 15 | Phtalonitrile | 2 | 83 | ∘ | 1 | ∘ | 81 | ∘ | 10 | ∘ |
| Example 48 | 29/61/10 | PAI | 15 | t-butylphtalonitrile | 2 | 78 | ∘ | 2 | ∘ | 76 | ∘ | 7 | ∘ |
| Example 49 | 29/61/10 | PAI | 15 | 2,2,2-trifluoroacetonitrile | 2 | 82 | ∘ | 2 | ∘ | 70 | ∘ | 6 | ∘ |
| Example 50 | 29/61/10 | PAI | 15 | 3-(2-fluoroethoxy)propionitrile | 2 | 73 | ∘ | 4 | ∘ | 68 | ∘ | 8 | ∘ |
| Example 51 | 29/61/10 | PAI | 15 | 2,5-difluorobenzonitrile | 2 | 76 | ∘ | 2 | ∘ | 51 | ∘ | 13 | ∘ |
| Example 52 | 29/61/10 | PAI | 15 | Tetrafluorophtalonitrile | 2 | 72 | ∘ | 3 | ∘ | 52 | ∘ | 18 | ∘ |
| Example 53 | 29/61/10 | PAI | 15 | Fluorobenzonitrile | 2 | 75 | ∘ | 2 | ∘ | 58 | ∘ | 9 | ∘ |
| Example 54 | 29/61/10 | PAI | 15 | 4-bromo-2-fluoronitrile | 2 | 78 | ∘ | 1 | ∘ | 57 | ∘ | 15 | ∘ |
| Example 55 | 29/61/10 | PAI | 15 | Bromoacetonitrile | 2 | 80 | ∘ | 1 | ∘ | 78 | ∘ | 11 | ∘ |
| Example 56 | 29/61/10 | PAI | 15 | α-bromobenzeneacetonitrile | 2 | 74 | ∘ | 4 | ∘ | 72 | ∘ | 11 | ∘ |
| Example 57 | 29/61/10 | PAI | 15 | Bromobenzylcyanide | 2 | 76 | ∘ | 2 | ∘ | 74 | ∘ | 7 | ∘ |
| Example 58 | 29/61/10 | PAI | 15 | Chlorobenzonitrile | 2 | 74 | ∘ | 5 | ∘ | 72 | ∘ | 10 | ∘ |
| Example 59 | 29/61/10 | PI | 15 | Butyronitrile | 2 | 77 | ∘ | 2 | ∘ | 73 | ∘ | 6 | ∘ |
| Example 60 | 29/61/10 | PI | 15 | 2-aminoacetonitrile | 2 | 70 | ∘ | 7 | ∘ | 61 | ∘ | 13 | ∘ |

TABLE 4

| | | | | | | 20° C. Cycle | | | | 60° C. Cycle | | | |
|---|---|---|---|---|---|---|---|---|---|---|---|---|---|
| | | Negative | | | | Maintenance | | Swelling | | Maintenance | | Swelling | |
| | | Electrode Binder | | | | Rate | | <Volume> | | Rate | | <Volume> | |
| | Si/SiO/C | | Content | | Content | | Judg- | | Judg- | | Judg- | | Judg- |
| | Ratio | Kind | (%) | Nitrile compound | (%) | (%) | ment | (%) | ment | (%) | ment | (%) | ment |
| Example 61 | 29/61/10 | PI | 15 | Malononitrile | 2 | 79 | ∘ | 1 | ∘ | 75 | ∘ | 5 | ∘ |
| Example 62 | 29/61/10 | PI | 15 | Adiponitrile | 2 | 74 | ∘ | 3 | ∘ | 71 | ∘ | 8 | ∘ |
| Example 63 | 29/61/10 | PI | 15 | Benzonitrile | 2 | 73 | ∘ | 4 | ∘ | 70 | ∘ | 10 | ∘ |
| Example 64 | 29/61/10 | PI | 15 | 2,5-difluoro- | 2 | 75 | ∘ | 3 | ∘ | 66 | ∘ | 11 | ∘ |
| | | | | benzonitrile | | | | | | | | | |
| Comparative | 29/61/10 | PVdF | 15 | None | 0 | 42 | x | 35 | x | 32 | x | 40 | x |
| Example 1 | | | | | | | | | | | | | |
| Comparative | 29/61/10 | PI | 15 | None | 0 | 48 | x | 25 | x | 42 | x | 35 | x |
| Example 2 | | | | | | | | | | | | | |
| Comparative | 29/61/10 | PAI | 15 | None | 0 | 47 | x | 28 | x | 41 | x | 24 | x |
| Example 3 | | | | | | | | | | | | | |
| Comparative | 29/61/10 | PVdF | 15 | Butyronitrile | 2 | 51 | x | 22 | x | 49 | x | 24 | x |
| Example 4 | | | | | | | | | | | | | |
| Comparative | 0/0/100 | PVdF | 15 | None | 0 | 40 | x | 38 | x | 34 | x | 42 | x |
| Example 5 | | | | | | | | | | | | | |
| Comparative | 0/0/100 | PI | 15 | None | 0 | 57 | x | 21 | x | 47 | x | 29 | x |
| Example 6 | | | | | | | | | | | | | |

The present application claims the priority to Japanese Patent Application No. 2010-196622, filed on Sep. 2, 2010, the disclosure of which is incorporated herein by reference in its entirety.

Hitherto, the invention of the present application has been described with reference to the exemplary embodiment and Examples, but the invention of the present application is not limited to the above-mentioned exemplary embodiment and Examples. In the constitutions and details of the invention of the present application, various changes which are understood by a person skilled in the art can be made within the scope of the invention.

### INDUSTRIAL APPLICABILITY

The present exemplary embodiment can be utilized in every industrial field necessitating an electric power source, and industrial fields related to the transportation, storage, and supply of electric energy. Specifically, the present exemplary embodiment can be utilized in electric power sources for mobile devices such as cell phones and notebook personal computers; electric power sources for movement and transportation media including electric vehicles such as electric cars, hybrid cars, electric motorbikes and electric assist bicycles, and electric trains, satellites and submarines; backup electric power sources such as UPS; electric power storage facilities to store electric power generated by photovoltaic power generation, wind power generation and the like; and the like.

### THE DESCRIPTION OF REFERENCE MARKS

a: negative electrode

b: separator

c: positive electrode

d: negative electrode current collector

e: positive electrode current collector

f: positive electrode terminal

g: negative electrode terminal

1. A secondary battery, comprising an electrode assembly in which a positive electrode and a negative electrode are arranged to face each other, an electrolyte liquid and a package accommodating the electrode assembly and the electrolyte liquid,
wherein the negative electrode is formed by binding a negative electrode active substance comprising a metal (a) capable of being alloyed with lithium, a metal oxide (b) capable of occluding and releasing lithium ions and a carbon material (c) capable of occluding and releasing lithium ions, to a negative electrode current collector, with at least one selected from polyimides and polyamideimides, and
the electrolyte liquid comprises a nitrile compound that is represented by the following general formula (1), and
the electrode assembly has a stacked structure, and
the package is a laminate film.
R1-CN (1)
[R1 denotes a substituted or non-substituted saturated hydrocarbon group or a substituted or non-substituted aromatic hydrocarbon group.]

2. The secondary battery according to claim 1, wherein the nitrile compound is a compound that is represented by the following general formula (2). 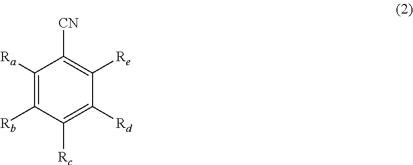
[Ra to Re each independently denote hydrogen atom, an alkyl group, a cyano group or a halogen atom.]

3. The secondary battery according to claim 1, wherein the nitrile compound has at least one fluorine atom.

4. The secondary battery according to claim 1, wherein the electrolyte liquid further comprises a linear-type or cyclic-type carbonate.

5. The secondary battery according to claim 4, wherein a content of the nitrile compound is 1-30% by mass with respect to the total amount of the nitrile compound and the carbonate.

6. The secondary battery according to claim 1, wherein the whole or a part of the metal oxide (b) has an amorphous structure.

7. The secondary battery according to claim 1, wherein the metal oxide (b) is an oxide of a metal constituting the metal (a).

8. The secondary battery according to claim 1, wherein the metal (a) is silicon.

9. The secondary battery according to claim 1, wherein the whole or a part of the metal (a) is dispersed in the metal oxide (b).

10. The secondary battery according to claim 1, wherein the package is an aluminum laminate film.

11. The secondary battery according to claim 2, wherein the nitrile compound has at least one fluorine atom.

12. The secondary battery according to claim 2, wherein the electrolyte liquid further comprises a linear-type or cyclic-type carbonate.

13. The secondary battery according to claim 3, wherein the electrolyte liquid further comprises a linear-type or cyclic-type carbonate.

14. The secondary battery according to claim 1, wherein the metal (a) is silicon, and the metal oxide (b) is silicon oxide, and the whole or a part of the metal (a) is dispersed in the metal oxide (b).

15. The secondary battery according to claim 2, wherein the metal (a) is silicon, and the metal oxide (b) is silicon oxide, and the whole or a part of the metal (a) is dispersed in the metal oxide (b).

16. The secondary battery according to claim 3, wherein the metal (a) is silicon, and the metal oxide (b) is silicon oxide, and the whole or a part of the metal (a) is dispersed in the metal oxide (b).

17. The secondary battery according to claim 4, wherein the metal (a) is silicon, and the metal oxide (b) is silicon oxide, and the whole or a part of the metal (a) is dispersed in the metal oxide (b).

18. The secondary battery according to claim 5, wherein the metal (a) is silicon, and the metal oxide (b) is silicon oxide, and the whole or a part of the metal (a) is dispersed in the metal oxide (b).
